(19) United States
(12) Patent Application Publication
(10) Pub. No.: US 2006/0113160 A1
(43) Pub. Date: Jun. 1, 2006

(54) Bill processing apparatus

(76) Inventors: Noboru Yamagishi, Saitama (JP); Nobuyuki Iida, Saitama (JP); Yukio Ito, Saitama (JP)

Correspondence Address: FISH & RICHARDSON P.C., P.O. BOX 1022, MINNEAPOLIS, MN, 55440-1022, US

(21) Appl. No.: 11/291,035

(22) Filed: Nov. 29, 2005

(30) Foreign Application Priority Data
Nov. 30, 2004 (JP) 2004-345252

(51) Int. Cl. G07F 7/04

(52) U.S. Cl. 194/206

(57) ABSTRACT

A bill processing apparatus which has a shutter portion for opening and closing a bill conveyance path and a stack portion for storing a bill guided along the bill conveyance path into a bill storage portion, and which includes a driver portion that causes a single drive portion (stack motor) to drive the shutter portion and the stack portion, in which the drive portion comprises a first driving member (a front end of a stack link) that drives the shutter portion and a second driving member (protruding face of the stack link) that drives the stack portion; and an unoperated region in which the shutter portion or the stack portion does not operate with respect to the operation of at least one of the first driving member and the second driving member.

### BACKGROUND OF THE INVENTION

1. Field of the Invention

The present invention relates to a bill processing apparatus that is used in automatic vending machines, change machines, pachinko ball lending machines, medal lending machines, and the like (referred to as “automatic vending machines and the like” hereinafter).

2. Description of the Related Art

Generally, the inside of a machine main body of an automatic vending machine or the like that manages bills (including coupons and the like) is installed with a bill processing apparatus which is designed to distinguish the authenticity of an inserted bill, accumulate and store only the bills that have been identified as authentic.

Such conventional bill processing apparatus has bill conveyance means for conveying a bill which is inserted into a bill slot to a bill conveyance path and temporarily holds the bill at the middle of the bill conveyance path, a bill-discriminating portion for distinguishing the authenticity of the bill which is held temporarily, shutter means for opening and closing the bill conveyance path on the basis of a result of distinction, and stack means for storing bills that have been identified as authentic into a bill storage portion.

Moreover, in the conventional bill processing apparatus, there is a bill processing apparatus in which the shutter means and stack means described above are driven by means of a common drive source. Japanese Patent Application Laid-Open No. 2002-230621 (FIG. 1, FIG. 7, FIG. 8, and FIG. 9) should be referenced.

FIG. 15(a) and FIG. 15(b) are schematic diagrams showing the operation of the conventional bill processing apparatus in which the shutter means and stack means are driven by means of a common drive source. Particularly, FIG. 15(a) shows a state in which an upstream of the bill conveyance path is opened by the shutter means, and FIG. 15(b) shows a state in which the upstream of the bill conveyance path is closed by the shutter means.

As sown in FIG. 15(a), in a conventional bill processing apparatus 100, a bill conveyance path 116 is formed such that it is communicated with a bill slot 115. Further, a bill storage passage area 110 (shown with a chain line) is formed such that it is communicated with a back end of the bill conveyance path 116.

Furthermore, shutter means 121 as a shutter lever is disposed in an upstream of the bill conveyance path 116.

In addition, stack means 111 for storing bills into a bill storage portion (not shown) is disposed in a position that faces the bill storage passage area 110 so as to have the bill storage portion therebetween. This stack means 111 is configured by a lift table 112 that pushes a surface of a bill guided to the bill storage passage area 110 toward the abovementioned bill storage portion.

Moreover, the shutter means 121 and the stack means 111 are connected to each other, and are driven in conjunction with each other by a common motor. It should be noted that this configuration is disclosed in, for example, the abovementioned Japanese Patent Application Laid-Open No. 2002-230621 (FIG. 1, FIG. 7, FIG. 8, and FIG. 9), thus it should be referenced.

In the conventional bill processing apparatus 100 having such configuration, when the upstream of the bill conveyance path 116 is opened by the shutter means 121, the back end of the bill conveyance path 116 is closed by the lift table 112, as shown in FIG. 15(a).

Here, when the abovementioned motor is driven, the upstream of the bill conveyance path 116 is closed by the shutter means 121, and the back end of the bill conveyance path 116 is closed by the lift table 112, as shown in FIG. 15(b).

Also, when the motor is driven in a state shown in FIG. 15(b), the upstream of the bill conveyance path 116 is opened by the shutter means 121, and the back end of the bill conveyance path 116 is closed by the lift table 112, as shown in FIG. 15(a).

Moreover, in the conventional bill processing apparatus 100 having such configuration, the upstream of the bill conveyance path 116 is opened by the shutter means 121 in a standby state, as shown in FIG. 15(a). When a bill is inserted into the bill slot 115, the bill is conveyed along the bill conveyance path 116 by the bill conveyance means.

When the conveyed bill reaches a predetermined position in the bill conveyance path 116, the bill conveyance means suspends the drive, whereby the bill is held temporarily inside the bill conveyance path 116. Thereafter, the upstream of the bill conveyance path 116 is closed by the shutter means 121, as shown in FIG. 15(b).

When a bill-discriminating portion identifies the bill, which has been held temporarily, as authentic after the upstream of the bill conveyance path 116 is closed, the bill is further guided along the bill conveyance path 116 by drive of the bill conveyance means.

When the bill is guided to the bill storage passage area 110, the motor is driven as shown in FIG. 15(a). Then, the lift table 112 pushes the surface of the bill, whereby the pushed bill is stored in the bill storage portion.

In the conventional bill processing apparatus 100 as described above, as shown in FIG. 15(a), during the period of time between the standby state and when the bill is to be held temporarily, the upstream of the bill conveyance path 116 is opened by the shutter means 121, and the back end of the bill conveyance path 116 is closed by the lift table 112, thus the bill which is to be held temporarily cannot be guided to the bill storage passage area 110.

Specifically, in the conventional bill processing apparatus, the bill storage passage area 110 cannot be used as a part of the passage for temporarily holding the bill.

For this reason, the bill conveyance path 116 needs to be formed to have a passage length that is necessary for temporarily holding the bill, that is, at least a passage length S which corresponds to the length of the longitudinal direction of the bill. Therefore, there was a problem that the bill processing apparatus 100 was big in size.

### SUMMARY OF THE INVENTION

An object of the present invention is to provide a compact bill processing apparatus.

In order to achieve the above-described object, an aspect of the present invention provides a bill processing apparatus having a shutter portion that opens and closes a bill conveyance path and a stack portion that stores a bill guided along the bill conveyance path into a bill storage portion, which includes a drive portion that causes a single drive portion to drive the shutter portion and the stack portion, in which the drive portion comprises a first driving member that drives the shutter portion and a second driving member that drives the stack portion; and an unoperated region in which the shutter portion or the stack portion does not operate with respect to the operation of at least one of the first driving member and the second driving member.

The bill processing apparatus of the present invention is configured to include the drive portion that causes a single drive portion to drive the shutter portion and the stack portion and has the first driving member that drives the shutter portion and the second driving member that drives the stack portion; and the unoperated region in which the shutter portion or the stack portion does not operate with respect to operation of at least one of the first driving member and the second driving member. Therefore, a state in which the bill conveyance path is opened by the shutter portion, and a back end of the bill conveyance path is not closed by the stack portion can be secured, whereby a bill storage passage area, which is communicated with the end of the bill conveyance path, can be used as a part of a passage for temporarily holding the bill.

Therefore, it is only necessary to secure a passage length that is required for temporarily holding a bill, that is, a passage length that corresponds to at least the longitudinal direction of the bill, by means of the bill conveyance path and the bill storage passage area, whereby miniaturization of the bill processing apparatus can be achieved.

It should be noted that another object and effects of the present invention can be learned easily through the following detailed description and the accompanying drawings.

### BRIEF DESCRIPTION OF THE DRAWINGS

FIG. 1 is a schematic cross sectional view of the bill processing apparatus of a first embodiment according to the present invention, and shows particularly a standby state of the bill processing apparatus;

FIG. 2 is a schematic perspective view of a substantial part of the bill processing apparatus of FIG. 1, and shows particularly a condition in which a bill storage portion is removed from an apparatus main body of FIG. 1;

FIG. 3 is a schematic perspective view of a substantial part of the bill processing apparatus of FIG. 1, and shows particularly a condition in which an upper chute is removed from the apparatus main body of FIG. 2;

FIG. 4 is a schematic perspective view of a substantial part of the bill processing apparatus of FIG. 1, and shows particularly a condition in which an exposed lift table is removed from the apparatus main body of FIG. 2;

FIG. 5(a) through FIG. 5(d) are figures showing a rotary operation of a stack cam of the bill processing apparatus of FIG. 1, where FIG. 5(a) is a figure showing a condition in which the bill processing apparatus is in the standby state, FIG. 5(b) is a figure showing a condition in which a bill is being conveyed, FIG. 5(c) is a figure showing a condition in which the bill is held temporarily and the inserted bill is identified as authentic; and FIG. 5(d) is a figure showing a condition in which stack operation is performed;

FIG. 6 is a schematic cross sectional view of the bill processing apparatus of the first embodiment of the present invention, and shows particularly a condition in which a stack portion does not operate when the bill conveyance path is opened by operation of a shutter portion, and it should be noted that FIG. 6 also shows a schematic enlarged view of a substantial part showing, in further detail, a condition of a carrier switch and a shutter of the lift table detected by the carrier switch;

FIG. 7 is an enlarged schematic broken-sectional view showing a condition in which a bill-discriminating portion and the lift table are also removed in addition to the upper chute shown in FIG. 3, and also shows operation of a drive portion;

FIG. 8 a schematic cross sectional view of the bill processing apparatus of the first embodiment of the present invention, and shows particularly a condition in which the stack portion does not operate when the bill which is guided to a bill storage passage area is held temporarily to close the bill conveyance path through operation of the shutter portion;

FIG. 9 is a schematic cross sectional view of the bill processing apparatus of the first embodiment, and shows particularly a condition in which the shutter portion does not operate when bill storage operation is performed by operation of the stack portion;

FIG. 10 is a schematic cross sectional view of a substantial part of the bill processing apparatus of a second embodiment of the present invention, and shows particularly a condition in which the bill storage operation is not performed by the stack portion, and a first passage is closed by the shutter portion;

FIG. 11 is a schematic cross sectional view of a substantial part of the bill processing apparatus of FIG. 10;

FIG. 12 is a schematic cross sectional view of a substantial part of the bill processing apparatus of a third embodiment of the present invention, and shows particularly a condition in which the bill storage operation is not performed by the stack portion, and a second passage is closed by the shutter portion;

FIG. 13 is a schematic cross sectional view of a substantial part of the bill processing apparatus of FIG. 12;

FIG. 14 is a schematic cross sectional view of a substantial part of the bill processing apparatus of a fourth embodiment of the present invention, and shows particularly a condition in which the bill storage operation is not performed by the stack portion, and the first passage is closed by the shutter portion; and

FIG. 15(a) and FIG. 15(b) are schematic views showing an operation of a conventional bill processing apparatus in which shutter means and stack means are driven by a common drive source, where FIG. 15(a) is a figure showing particularly a condition in which an upstream of a bill conveyance path is opened by the shutter means, and FIG. 15(b) is a figure showing particularly a condition in which the upstream of the bill conveyance means is closed by the shutter means.

### DETAILED DESCRIPTION OF THE INVENTION

Embodiments of the bill processing apparatus of the present invention are described hereinafter in detail.

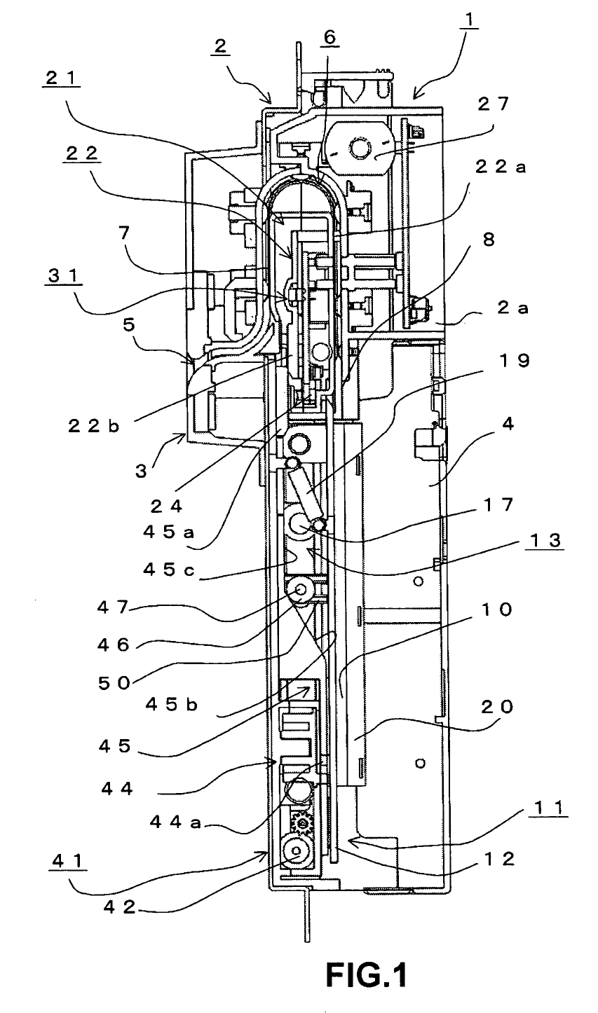

FIG. 1 is a schematic cross sectional view of the bill processing apparatus of a first embodiment of the present invention, and shows particularly a standby state of the bill processing apparatus.

As shown in FIG. 1, a bill processing apparatus 1 of the first embodiment comprises an apparatus main body 2, a front mask 3 which is threadably fixed on the front face of the apparatus main body 2, and a bill storage portion 4 which is supported by the back face of the main body 2.

A bill slot 5 is formed in the front mask 3. The front mask 3 is mounted such that the bill slot 5 is exposed to the outside from a front mask mounting hole which is formed on a door configuring the front face of an unshown automatic vending machine and the like.

Furthermore, a bill conveyance path 6 is formed on the apparatus main body 2.

The bill conveyance path 6 comprises a first passage 7 on the front mask 3 side, which is communicated with the bill slot 5, and a second passage 8 on the bill storage portion 4 side, which is communicated with the first passage 7 and which forms a back end of the bill conveyance path 6.

On the back end of the bill conveyance path 6, that is, the back end of the second passage 8, there is formed a bill storage passage area 10 along a vertical direction. A laterally-facing U-shaped stack guide 20 is formed on each end of the bill storage passage area 10 in the width direction. It should be noted that the stack guide 20 is a member for guiding a bill inserted into a groove of the stack guide 20, along the bill storage passage area 10.

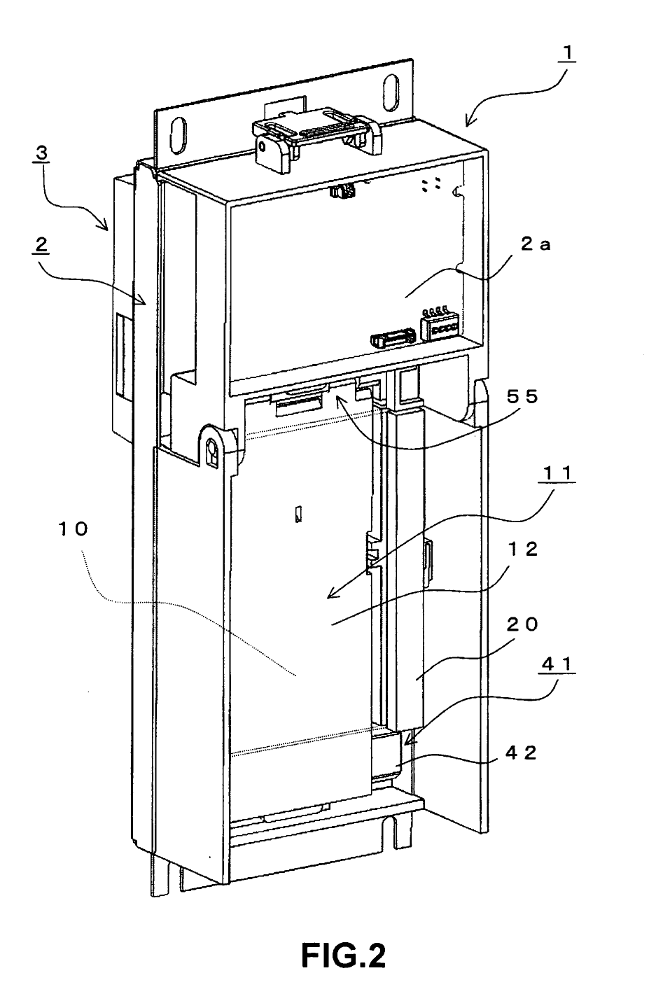

FIG. 2 is a schematic perspective view of a substantial part of the bill processing apparatus of FIG. 1, and shows particularly a condition in which the bill storage portion 4 is removed from the bill processing apparatus 1 of FIG. 1.

As shown in FIG. 2, a lift table 12 is disposed in the apparatus main body in a position that faces the bill storage portion 4 in FIG. 1 so as to have the bill storage passage area 10 therebetween.

The lift table 12 configures a stack portion 11 which pushes a bill guided to the bill storage passage area 10 and stores the bill into the bill storage portion.

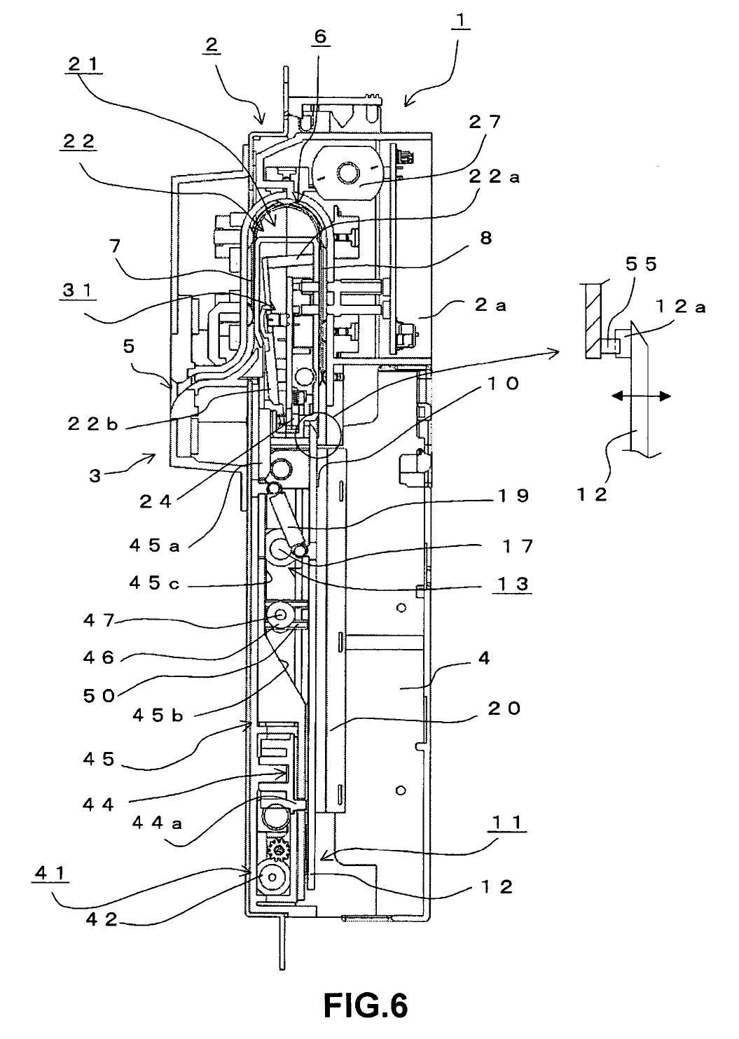

It should be noted in that a reference numeral 55 in FIG. 2 is a carrier switch which is disposed inside the apparatus main body 2. The carrier switch 55 is a sensor for detecting a shutter 12a (FIG. 6) which is located at an upper end of the lift table 12, and comprises a light-emitting element and a light-receiving element.

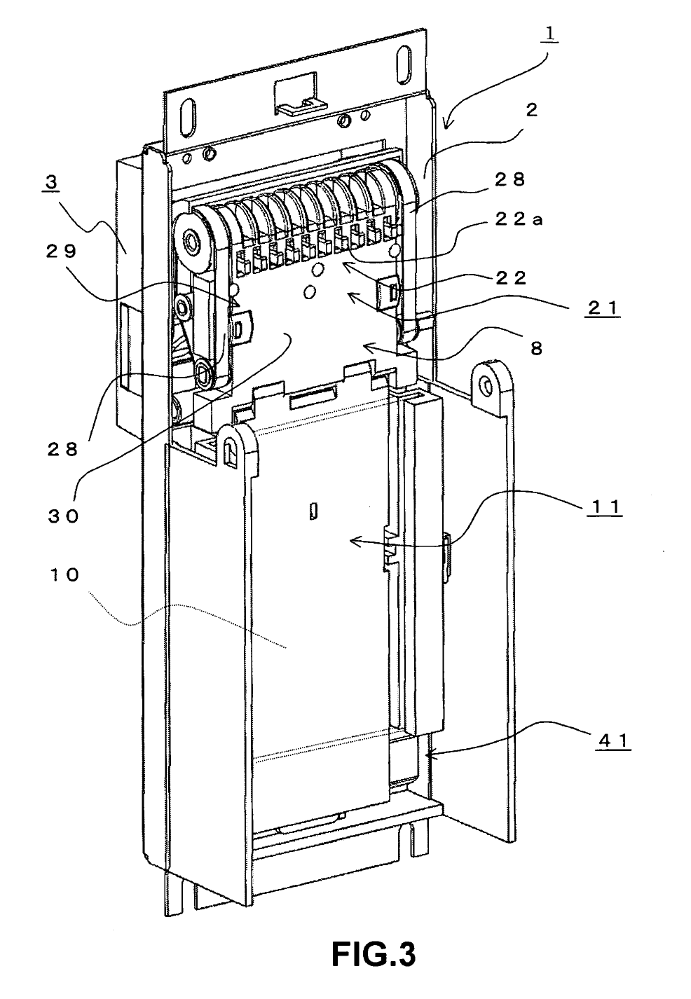

FIG. 3 is a schematic perspective view of a substantial part of the bill processing apparatus of FIG. 1, and shows particularly a condition in which an upper chute 2a is removed from the apparatus main body of FIG. 2.

When the upper chute 2a disposed in the main body 2 is removed, a bill-discriminating portion 30 is disposed inside the apparatus main body 2 as shown in FIG. 3. The bill-discriminating portion 30 and the upper chute 2a are detachably supported by the apparatus main body 2, and a shutter portion 21 is disposed in the bill-discriminating portion 30.

This shutter portion 21 is a portion for opening and closing the second passage 8, and comprises a shutter lever 22 which causes a front end 22a to be placed on the second passage 8, and an unshown shutter spring which biases a bearing portion 22b (FIG. 1) of the shutter lever 22 in the horizontal direction toward a side where the first passage 7 is formed.

Moreover, the shutter lever 22 comprises the bearing portion 22b which supports the front end 22a as shown in FIG. 1.

Furthermore, a shutter switch 31 which detects the bearing portion 22b is disposed in the vicinity of the bearing portion 22b, as shown in FIG. 1. It should be noted that the shutter switch 31 comprises a light-emitting element and a light-receiving element.

Further, a reference numeral 28 in FIG. 3 is a bill conveyance belt which conveys a bill along the first passage 7 and the second passage 8. The bill conveyance belt 28 is driven by a bill conveyance motor 27 which in the upper chute 2a shown in FIG. 1. In addition, a reference numeral 29 in FIG. 3 is a bill-discriminating portion which discriminates the authenticity of a bill. The bill-discriminating portion 29 is configured by a magnetic sensor and the like. It should be noted that the bill-discriminating portion 29 and the bill conveyance belt 28 are disposed in the abovementioned bill-discriminating portion 30.

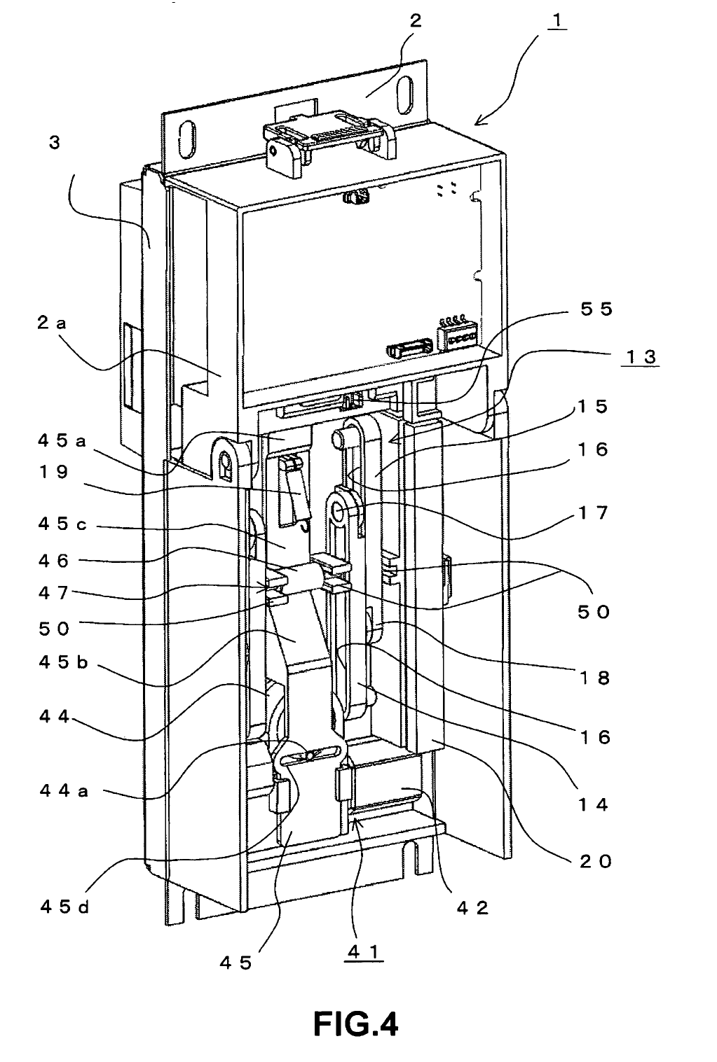

FIG. 4 is a schematic perspective view of a substantial part of the bill processing apparatus of FIG. 1, and shows particularly a condition in which the exposed lift table is removed from the apparatus main body of FIG. 2.

As shown in FIG. 4, there is disposed in the apparatus main body 2 a drive portion 41 which drives the shutter portion 21 and the stack portion 11.

The drive portion 41 comprises a stack motor 42, a stack cam 44 which is engaged with an unshown gear of the stack motor 42 and rotated, a stack link 45 which is engaged with the stack cam 44 and moved in a direction toward the shutter portion 21 (FIG. 1) or in the direction opposite therefrom, a stack roller 46 which moves up and down on an protruding face 45b from a position abutting on (or slightly distant from) a surface 45c of the stack link 45 by the movement of the stack link 45, a stack shaft 47 which supports the stack roller 46 and moves in a direction toward the bill storage portion 4 or in the direction opposite therefrom by the up and down movement of the stack roller 46, and a stack arm 13 having a pantograph structure, which fixes the stack shaft 47 by insertion, is engaged with the back face of the stack portion 11, and moves the stack portion 11 in a direction toward the bill storage portion 4 or in the direction opposite therefrom.

The stack motor 42 is a common drive source for driving the shutter portion 21 and the stack portion 11 shown in FIG. 1.

Further, the stack link 45 has a front end 45a disposed toward the shutter portion 21, the surface 45c formed along the direction perpendicular to the direction for the bill storage portion 4, and the protruding face 45b which protrudes toward the bill storage portion 4. It should be noted that the protruding face 45b and the surface 45c are connected to each other.

Moreover, a window that is passed through is provided in substantially a central portion of the surface 45c, and one end of a lift spring 19 is supported by a rib which passes through he window and is fixed to the apparatus main body 2. Another end of the lift spring 19 is coupled to the lift table 12, as shown in FIG. 1. The lift spring 19 constantly biases the lift table 12 toward the apparatus main body 2 side.

A long hole 45d into which a cam shaft 44a of the stack cam 44 is fitted by insertion is formed on a rear end portion of the stack link 45, as shown in FIG. 4.

The stack shaft 47 supports both ends of the stack roller 46. A guide 50 is disposed on each end of the stack shaft 47. The stack shaft 47 is fitted by insertion into a groove of the guide 50. The guide 50 is a guide member for restricting a movement of the stack roller 46 and stack shaft 47 in the direction toward the bill storage portion 4 and the direction opposite therefrom.

The stack arm 13 with a pantograph structure is disposed on an end of the stack shaft 47.

The stack arm 13 comprises a first arm 14 and a second arm 15, and a long hole 16 into which one end of the stack shaft 47 is fitted by insertion is formed in both the first arm 14 and the second arm 15.

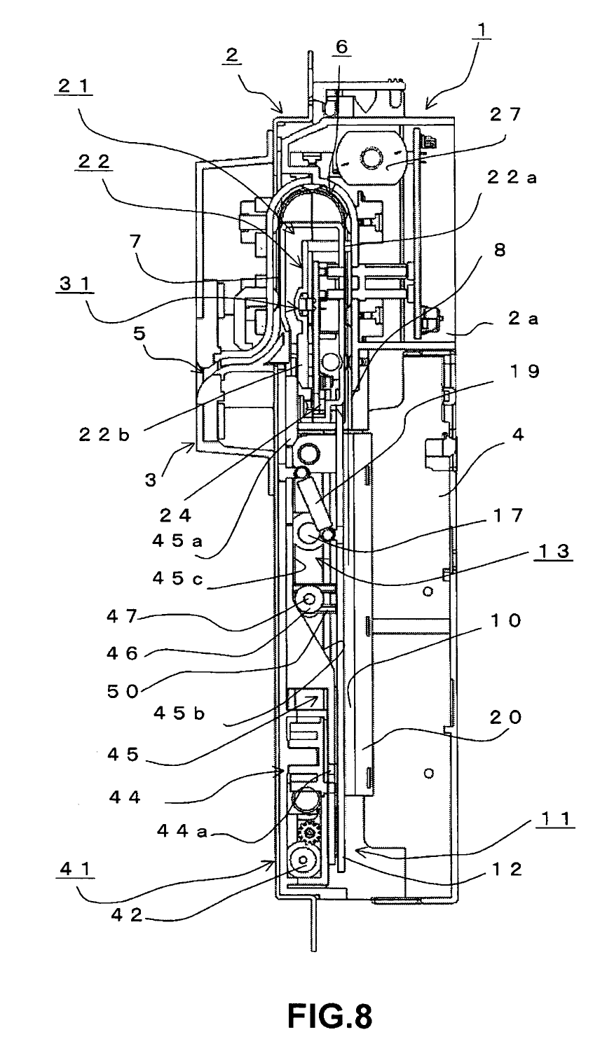

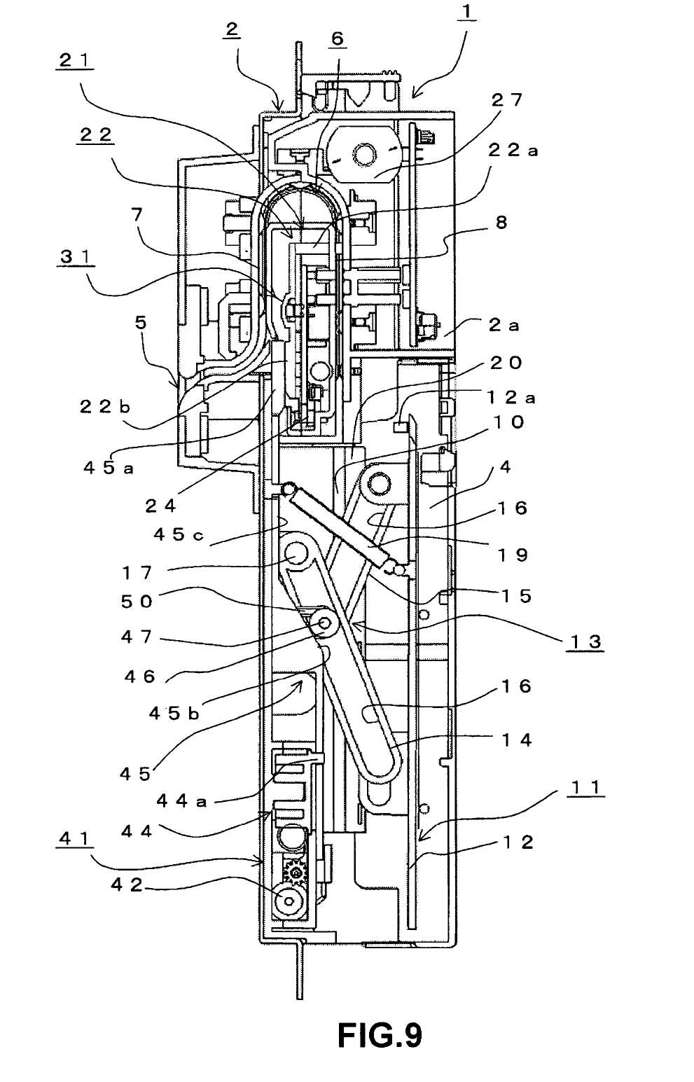

One of the ends of the first arm 14 is supported by a first axis 17 of the apparatus main body 2, and the other end is coupled to the lift table 12 as shown in FIG. 8 which is described hereinafter. One of the ends of the second arm 15 is supported by a second axis 18 of the apparatus main body 2, and the other end is coupled to the lift table 12 as shown in FIG. 9.

It should be noted that a reference numeral 55 in FIG. 4 is the carrier switch disposed in the apparatus main body 2 as described above. The carrier switch 55 is a sensor for detecting one end of the lift table 12, and comprises a light-emitting element and a light-receiving element.

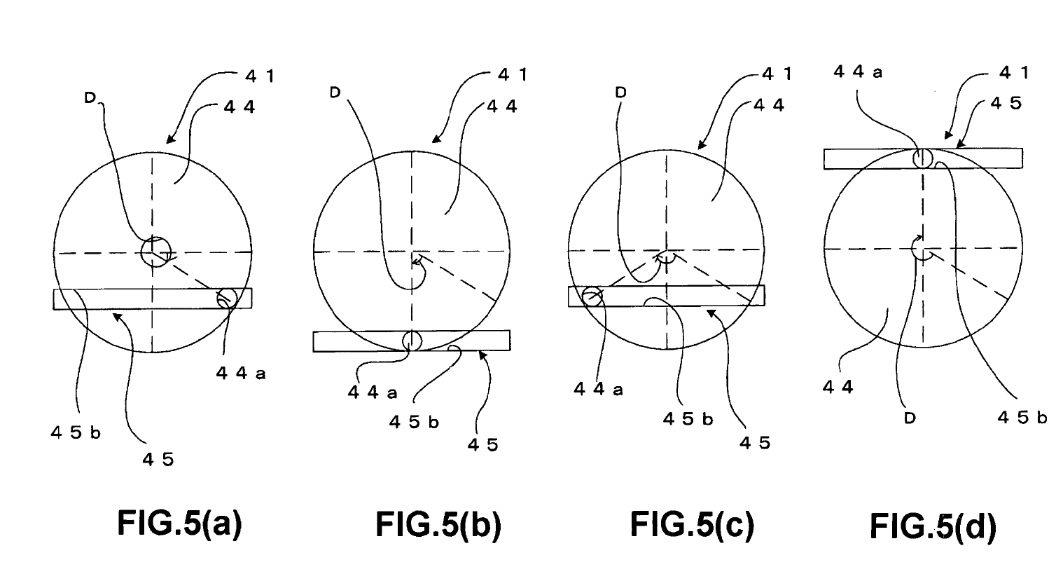

In the standby state of the bill processing apparatus 1 having such configuration, the cam shaft 44a is disposed in a position in which the cam 44 rotates by a first predetermined angle (for example, 60 degrees) toward one direction from the lowest point in the vertical direction, as shown in FIG. 4 and FIG. 5(a).

It should be noted that FIG. 5(a) through FIG. 5(d) are figures showing a rotary operation of the stack cam 44 of the bill processing apparatus of FIG. 1. Particularly, FIG. 5(a) is a figure showing a condition in which the bill processing apparatus is in the standby state, FIG. 5(b) is a figure showing a condition in which a bill is being conveyed, FIG. 5(c) is a figure showing a condition in which the bill is held temporarily and the inserted bill is identified as authentic; and FIG. 5(d) is a figure showing a condition in which stack operation is performed.

In the standby state shown in FIG. 1 and FIG. 5(a), the front end 45a of the stack link 45 comes behind the bearing portion 22b of the shutter lever 22 to press the bearing portion 22b. Therefore, as shown in FIG. 1, the shutter lever 22 rotates around a supporting point 24 while resisting the biasing force of an unshown shutter spring, and causes the front end 22a to protrude to the second passage 8, whereby the second passage 8 is closed.

Further, the shutter switch 31 (FIG. 1) is brought into a light-protected state, whereby the closing of the second passage 8 is detected.

In the standby state, the stack roller 46 is welded with pressure to (or placed slightly distant from) the surface 45c of the stack link 45.

Further, the stack arm 13 having a pantograph structure is caused to contract by the first arm 14 and the second arm 15, and also is disposed in a position farthest from the bill storage portion 4. Therefore, the back end of the second passage 8 is opened and not closed by the lift table 12. It should be noted that the bill storage passage area 10 is also opened.

Also, the carrier switch 55 is protected from light by one end of the lift table 12, thus it is detected that the lift table 12 is in a standby position where storage operation is not performed.

Next, when a bill is inserted, as shown in FIG. 5(b), the insertion is detected and the bill conveyance motor 27 is driven, whereby the bill conveyance belt 28 (FIG. 3) is turned, and the stack motor 42 is driven to rotate the stack cam 44 in the other direction.

Consequently, the bill is guided along the first passage 7 of the bill conveyance path 6 by the conveyance belt 28 being driven. Thereafter, the bill is guided along the second passage 8.

Moreover, as shown in FIG. 6, the stack link 45 moves downward along with the cam shaft 44a along the vertical direction by the rotation of the stack cam 44. Further, the stack link 45 which moves downward gradually separates the front end 45a from the bearing portion 22b of the shutter lever 22 by means of the biasing force of the shutter spring, and gradually releases the state where the front end 45a comes behind the bearing portion 22b to press the bearing portion 22b.

Then, as shown in FIG. 5(b), when a rotation angle D of the stack cam 44 reaches the first predetermined angle (for example, 60 degrees), the cam shaft 44a and the stack link 45 reach the lowest points in the vertical direction respectively. Further, as shown in FIG. 6, the front end 45a of the stack link 45 then finally separates from the bearing portion 22b of the shutter lever 22 completely, whereby the state where the front end 45a was behind the bearing portion 22b to press the bearing portion 22b is released completely

Therefore, the shutter lever 22 is caused to rotate around the supporting point 24 by the biasing force of the shutter spring, and the front end 22a is caused to withdraw from the second passage 8, whereby the second passage 8 is opened.

It should be noted that this opening of the second passage 8 is detected by the shutter switch 31 being lighted by the bearing portion 22b of the shutter lever 22.

Moreover, after the second passage 8 is opened by the shutter lever 22, the bill-discriminating portion 29 (FIG. 3) distinguishes the authenticity of the inserted bill. (When distinguishing bills, the inserted bill is caused to stop at an escrow position.)

Here, when the bill is identified as authentic, the stack motor 42 is driven, and the stack cam 44 is further rotated in the other direction. Then, when the rotation angle D reaches a second predetermined angle (for example, 120 degrees) as shown in FIG. 5(c), the drive of the stack motor 42 is stopped.

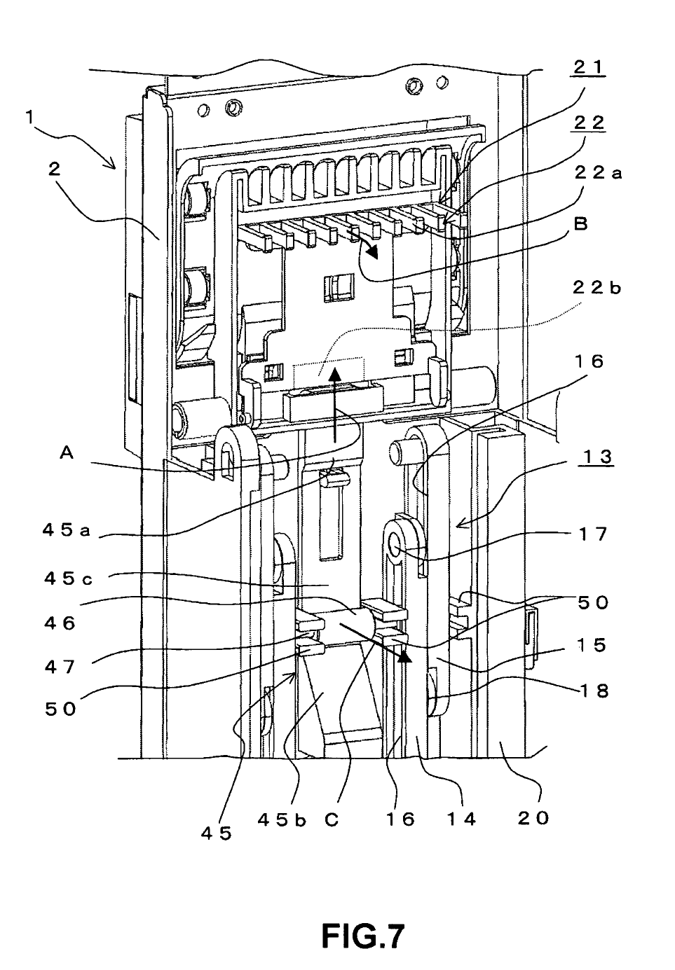

Accordingly, as shown with an arrow A in FIG. 7, the stack link 45 moves upward toward the shutter lever 22 along with the cam shaft 44a along the vertical direction. Further, as shown in with an arrow B in FIG. 7, the front end 45a of the stack link 45 which has moved upward tries to gradually come behind the bearing portion 22b of the shutter lever 22 while resisting the biasing force of the shutter spring, to press the back face of the bearing portion 22b.

As shown in FIG. 8, when the rotation angle D of the stack cam 44 reaches the second predetermined angle (for example, 120 degrees) and the stack motor 42 is stopped, the front end 45a of the stack link 45 finally comes behind the bearing portion 22b and presses the back face of the bearing portion 22b. Therefore, the shutter lever 22 which has been pressed against the bearing portion 22b rotates around the supporting point 24 and causes the front end 22a to protrude to the second passage 8, whereby the second passage 8 is closed. It should be noted that the closing of the second passage 8 is detected by the shutter switch 31 being brought into the light-protected state.

Moreover, when the second passage 8 is closed, the rear end of the bill that was guided along the second passage 8 has already passed the front end 22a of the shutter lever 22, thus the drive of the bill conveyance belt 28 is stopped. Then, the bill is held temporarily at a position where the rear end of the bill has passed the front end 22a of the shutter lever 22.

It should be noted that the second passage 8 which is located downstream of the rear end of the bill is closed by the front end 22a of the shutter lever 22, thus mischief such as taking the held bill from the bill slot 5 is prevented as much as possible.

In addition, the lift table 12 does not move from the standby position during the period of time between the standby state and when the bill is held temporarily.

Specifically, the protruding face 45b of the stack link 45 gradually separates from or approaches the stack roller 46 by the downward movement or upward movement of the stack link 45, but the stack roller 46 is welded with pressure to (or slightly distant from) the surface 45c, thus it does not move in a direction toward the bill storage portion 4.

For this reason, the stack roller 46 and the stack shaft 47 remain in the standby position without moving in a direction toward the bill storage portion 4, whereby the stack arm 13 having a pantograph structure and the lift table 12 also remain in the standby position.

Therefore, when temporarily holding the bill, the back end of the second passage 8 is maintained in an opened state without being closed by the stack portion 11. When temporarily holding the inserted bill in this manner, since the back end of the second passage 8 is opened, the bill can be held temporarily at a position where the front end of the bill is guided into the bill storage passage area 10, as shown in FIG. 8.

It should be noted that the carrier switch 55 is protected from light by one end of the lift table 12, thereby detecting that the standby position is maintained.

Also, the abovementioned FIG. 6 is a schematic cross sectional view of the bill processing apparatus of the first embodiment, and shows particularly a condition in which the stack portion does not operate when the bill conveyance path is opened by operation of the shutter portion, and it should be noted that FIG. 6 also shows a schematic enlarged view of a substantial part showing, in further detail, a condition of the carrier switch 55 and the shutter 12a of the lift table 12 detected by the carrier switch. FIG. 7 is an enlarged schematic broken-sectional view showing a condition in which the bill-discriminating portion 29 and the lift table 12 are also removed in addition to the upper chute 2a shown in FIG. 3, and also shows operation of the drive portion. FIG. 8 a schematic cross sectional view of the bill processing apparatus of the first embodiment, and shows particularly a condition in which the stack portion does not operate when the bill which is guided to the bill storage passage area is held temporarily to close the bill conveyance path through operation of the shutter portion.

Furthermore, in an automatic vending machine or the like in which the bill processing apparatus 1 is disposed, after a purchase button for purchasing a product is pressed and thereupon the product is delivered, the bill which has been held temporarily is further conveyed by the drive of the bill conveyance belt 28.

When the rear end of the bill to be conveyed reaches the bill storage passage area 10, the stack motor 42 is driven, and the stack cam 44 shown in FIG. 5(c) is caused to further rotate in the other direction. The stack cam 44 keeps rotating until the rotation angle D reaches a third predetermined angle (for example, 240 degrees) as shown in FIG. 5(d).

Consequently, the stack link 45 moves upward along with the cam shaft 44a along the vertical direction. Then, when the rotation angle D of the stack cam 44 reaches the third predetermined angle (for example, 240 degrees), the cam shaft 44a and the stack link 45 reach the highest points in the vertical direction respectively.

Moreover, as shown in FIG. 9, the stack roller 46 moves upward along the protruding face 45b by the upward movement of the stack link 45. Then, when the rotation angle D of the stack cam 44 reaches the third predetermined angle (for example, 240 degrees), the stack roller 46 reaches the highest position on the protruding face 45b. When the stack roller 46 moves up, the stack shaft 47 is guided in a direction toward the bill storage portion 4, that is, the direction indicated with an arrow C in FIG. 7, by the inclination of the protruding face 45b.

When the stack shaft 47 is moved in the direction toward the bill storage portion 4 in the manner described above, the first arm 14 configuring the stack arm 13 having a pantograph structure rotates around the first axis 17 in one direction to cause the lift table 12 to move toward the bill storage portion 4, and the second arm 15 rotates around the second axis 18 in another direction to cause the lift table 12 to move toward the bill storage portion side, as shown in FIG. 9. Therefore, the entire stack arm 13 extends while resisting the lift spring 19, and the lift table 12 passes transversely across the back end of the second passage 8 and the bill storage passage area 10 to move to the bill storage portion 4 side. Then, when the rotation angle D of the stack cam 44 reaches the third predetermined angle (for example 240 degrees), the lift table 12 reaches a position most proximate to the bill storage portion 4.

Furthermore, the lift table 12 presses the bill disposed in the bill storage passage area 10 toward the bill storage portion 4 side. For this reason, the pressed bill is stored in the bill storage portion 4 after the both ends of the bill in the width direction are ejected from the grooves of the respective stack guides 20.

It should be noted that the fact that the lift table 12 is moved from the standby position is detected when the carrier switch 55 is brought into the lighted state.

On the other hand, although the front end 45a of the stack link 45 is moved upward along the vertical direction by the upward movement of the stack link 45, the state in which the front end 45a comes behind the bearing portion 22b of the shutter lever 22 to press the bearing portion 22b is still maintained. Therefore, as shown in FIG. 9, the shutter lever 22 keeps the state where the front end 22a is caused to protrude toward the second passage 8, whereby the second passage 8 remains closed. It should be noted that the maintenance of the closed state is detected by the light-protected state of the shutter switch 31 being maintained.

Note that FIG. 9 is a schematic cross sectional view of the bill processing apparatus of the first embodiment, and shows particularly a condition in which the shutter portion does not operate when bill storage operation is performed by operation of the stack portion.

After the bill is store, the stack motor 42 is further driven, whereby the stack cam 44 shown in FIG. 5(d) is caused to further rotate in the other direction until the rotation angle D reaches a fourth predetermined angle (for example 360 degrees), as shown in FIG. 5(a).

Consequently, the stack link 45 moves downward along with the cam shaft 44a along the vertical direction. Moreover, the stack roller 46 descends along the protruding face 45b by this downward movement of the stack link 45.

When the stack link 45 descends, the stack roller 46 and the stack shaft 47 are guided in the direction opposite from the direction toward the bill storage portion 4 by the inclination of the protruding face 45b.

When the stack shaft 47 moves in the direction opposite from the direction toward the bill storage portion 4, the first arm 14 configuring the stack arm 13 rotates around the first axis 17 in the other direction to cause the lift table 12 to move in the direction opposite from the direction toward the bill storage portion 4, and the second arm 15 rotates around the second axis 18 in one direction to cause the lift table 12 to move in the direction opposite from the direction toward the bill storage portion 4. Therefore, the entire stack arm 13 is caused to contract by the biasing force of the lift spring 19, and the lift table 12 passes transversely across the back end of the second passage 8 and the bill storage passage area 10 again to move in the direction opposite from the direction toward the bill storage portion 4.

Then, when the rotation angle D of the stack cam 44 reaches the fourth predetermined angle (for example 360 degrees), the stack roller 46 descends along the protruding face 45b, then finally reaches the surface 45c, and is welded with pressure to (or slightly separates from) the surface 45c (see FIG. 1). For this reason, the stack roller 46 and the stack shaft 47 no longer move in the direction toward the bill storage portion 4. Therefore, the stack roller 46 and the stack shaft 47 return to the standby position by means of the biasing force of the lift sprint 19, and the stack arm 13 having a pantograph structure also returns to the standby position which is farthest from the bill storage portion 4. Accordingly, the lift table 12 also returns to the standby position, whereby the back end of the second passage 8 is opened.

It should be noted that returning to the standby position is detected by the carrier switch 55 being protected from light by one end of the lift table 12.

Moreover, by the downward movement of the stack link 45, its front end 45a also moves downward along the vertical direction, but the state in which the front end 45a comes behind the bearing portion 22b of the shutter lever 22 to press the bearing portion 22b is still maintained. Therefore, the shutter lever 22 keeps the state where the front end 22a is caused to protrude toward the second passage 8, whereby the second passage 8 remains closed. It should be noted that the maintenance of the closed state of the second passage 8 is detected by the light-protected state of the shutter switch 31 being maintained.

When the rotation angle D of the stack cam 44 reaches the fourth predetermined angle (for example, 360 degrees) as shown in FIG. 5(a), the drive of the stack motor 42 is stopped. Consequently, the bill processing apparatus returns to the standby state shown in FIG. 1.

On the other hand, in the case where the bill is held temporarily as described above, when the bill discriminating portion 29 identifies the bill as counterfeit, the stack cam 44 remains in the state shown in FIG. 5(b), and reversely drives the bill conveyance belt 28. Then, the bill identified as counterfeit is guided along the second passage 8, thereafter guided to the first passage 7, and returned from the bill slot 5.

After the bill is returned as described above, when the stack motor 42 is reversely driven and the stack cam is caused to return to the rotational position shown in FIG. 5(a), the bill processing apparatus 1 returns to the standby state shown in FIG. 1.

As is understood from above, the bill processing apparatus 1 has an unoperated region in which the stack portion 11 does not operate, particularly an unoperated region in which the stack portion does not operate from the standby state, with respect to operation of the first driving member which drives the shutter portion 21, that is, for example, operation of the front end 45a of the stack link 45. Accordingly, a state in which the second passage 8 is opened by the shutter portion 21 and the back end of the second passage 8 is not closed by one end of the lift table 12 can be secured (FIG. 6).

Further, the bill processing apparatus 1 has an unoperated region in which the shutter portion 21 does not operate, particularly an unoperated region which maintains the closed state of the second passage 8, with respect to operation of the second driving member which drives the stack portion 11, that is, for example, the protruding face 45b of the stack link 45. Accordingly, a state in which the second passage 8 is opened by the shutter portion 21 and the back end of the second passage 8 is not closed by one end of the lift table 12 can be secured.

It should be noted in the above description that the second driving member for driving the stack portion 11 is described as the protruding face 45b of the stack link 45; however, the second driving member of the bill processing apparatus of the present invention is same as, for example, the stack shaft 47, stack roller 46, or stack arm 13.

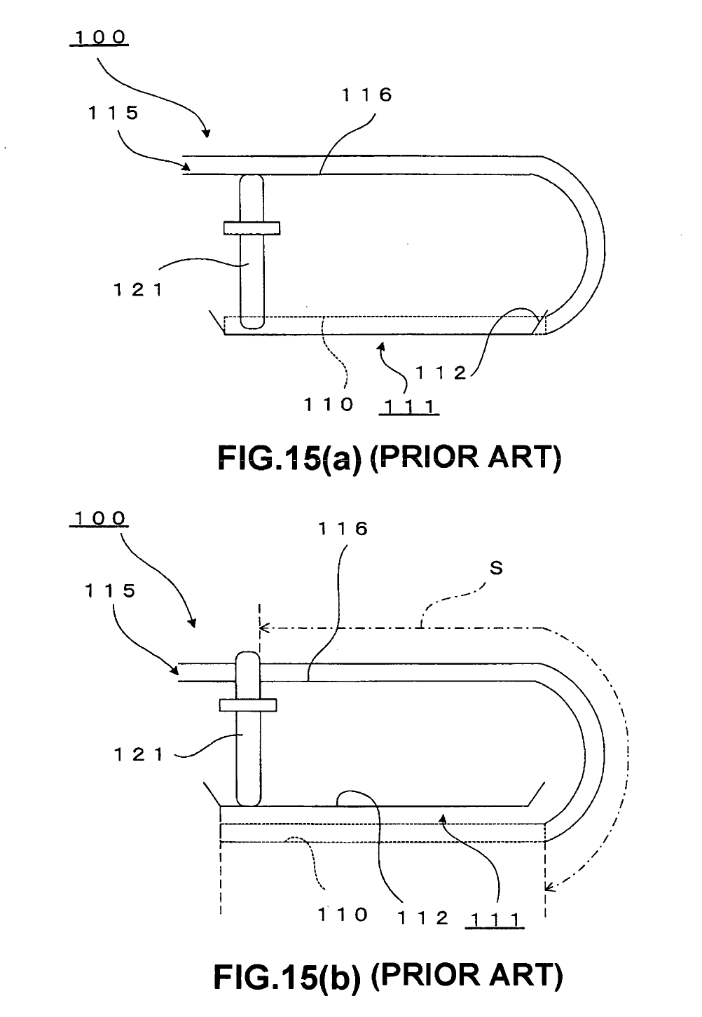

If it is possible to secure a state in which the second passage 8 is opened by the shutter portion 21 and the back end of the second passage 8, that is, the back end of the bill conveyance path 6, is not closed by one end of the lift table 12, the bill storage passage area 10 which is communicated with the back end of the bill conveyance path 6 can be used as a part of the passage for temporarily holding the bill, as shown in FIG. 8. For this reason, in the bill processing apparatus 1, it is only necessary to secure a passage length that is required for temporarily holding a bill, that is, the passage length S (see FIG. 15(b)) that corresponds to at least the longitudinal direction of the bill, by means of the bill conveyance path 6 and the bill storage passage area 10, whereby miniaturization of the bill processing apparatus 1 can be achieved.

As described above, the bill processing apparatus 1 of the first embodiment of the present invention comprises: the drive portion 41 which causes a single drive portion (stack motor 42) to drive the shutter portion 21 and the stack portion 11, the drive portion 41 having the first driving member which drives the shutter portion 21 and the second driving member which drives the stack portion 11; and the unoperated region in which the shutter portion 21 or the stack portion 11 does not operate with respect to operation of at least one of the first driving member and the second driving member. Therefore, a state in which the back end of the bill conveyance path 6 is closed by the stack portion 11 when the bill conveyance path 6 is opened by the shutter portion 21 can be prevented, whereby the bill storage passage area, which is communicated with the back end of the bill conveyance path 6, can be used as a part of the passage for temporarily holding the bill.

Therefore, it is only necessary to secure a passage length that is required for temporarily holding a bill, that is, the passage length S that corresponds to at least the longitudinal direction of the bill by means of the bill conveyance path 6 and the bill storage passage area 10, whereby miniaturization of the bill processing apparatus 1 can be achieved.

It should be noted that the drive portion 41 of the bill processing apparatus of the present invention has the unoperated region in which the shutter portion 21 or the stack portion 11 does not operate with respect to operation of at least one of the first driving member and the second driving member. However the drive portion 41 of the bill processing apparatus can be configured such that the shutter portion 21 does not operate with respect to operation of the first driving member, that is, for example, the front end 45a of the stack link 45. Even in the case of having such configuration, a state in which the bill conveyance path 6 is opened by the shutter portion 21 and the back end of the bill conveyance path 6 is closed by the stack portion 11 can be secured, whereby the bill storage passage area 10, which is communicated with the back end of the bill conveyance path 6, can be used as a part of the passage for temporarily holding the bill, and miniaturization of the bill processing apparatus can be achieved.

Furthermore, in the bill processing apparatus 1, when driving the shutter portion 21 by means of the stack motor 42, the shutter portion 21 is disposed not in the upper chute 2a (FIG. 1) as in the conventional bill processing apparatus, but inside the apparatus main body 2, and also disposed in the bill-discriminating portion 30 that is detachably mounted on the apparatus main body 2. Therefore, the structure of the bill processing apparatus becomes simpler in comparison with the conventional bill processing apparatus.

Moreover, in the bill processing apparatus 1, the shutter portion 21 and the stack portion 11 are driven by the stack motor 42 as the common drive source, thus the number of parts can be reduced as compared to the conventional bill processing apparatus that independently has a solenoid for driving the shutter portion 21 and a motor for driving the stack portion 11, whereby the production cost can be reduced.

In addition, in the bill processing apparatus 1, when performing the bill storage operation shown in FIG. 9, the second passage 8 which is located in a position distant from the bill slot 5 is closed by the shutter portion 21, thus mischief such as taking the bill from the bill slot 5 is prevented as much as possible.

In the bill processing apparatus 1, in the bill conveyance path 6 the shutter portion 21 is disposed in the second passage 8 communicated with the first passage, instead of in the first passage 7 communicated with the bill slot 5. For this reason, in comparison with the case where the shutter portion is disposed in the first passage 7, the shutter portion 21 is disposed in a position which is as distant as possible from the bill slot 5, whereby mischief such as manipulating the shutter portion 21 forcibly from the bill slot 5 can be prevented as much as possible.

It should be noted that in the bill processing apparatus 1 of the first embodiment, the shutter portion 21 is disposed in the second passage 8. However, position for disposing the shutter portion 21 is not limited to this in the bill processing apparatus of the present invention, thus the shutter portion 21 may be disposed in the first passage 7, for example.

In the bill processing apparatus 1, as described above, the drive portion 41 comprises: the stack motor 42; the stack cam 44 which is engaged with the stack motor 42 and turned; the front end 45a disposed toward the shutter portion 21; the stack link 45 which has the surface 45c formed along the direction perpendicular to the direction toward the bill storage portion 4, the protruding face 45b connected to the surface 45c and protruding toward the bill storage portion 4, is engaged with the stack cam 44, moves in a direction toward the shutter portion 21 or in the direction opposite therefrom, and causes the shutter portion 21 to operate by means of the front end 45a; the stack roller 46 which moves up and down on the protruding face 45b from a position abutting on (or slightly distant from) the surface 45c as the stack link 45 moves; the stack shaft 47 which supports the stack roller 46 and moves in a direction toward the bill storage portion 4 or in the direction opposite therefrom as the stack roller 46 moves up; and the stack arm 13 having a pantograph structure, which fixes the stack shaft 47 by insertion, is engaged with the stack portion 11, and moves the stack portion 11 in a direction toward the bill storage portion 4 or in the direction opposite therefrom. Accordingly, the first driving member for driving the shutter portion 21 is configured by, for example, the front end 45a of the stack link 45, which is engaged with the shutter portion 21, and the second driving member for driving the stack portion 11 is configured by, for example, the protruding face 45b of the stack link 45, which abuts on the stack roller 46. In the bill processing apparatus 1 of the first embodiment described above, however, particularly the surface 45c is made flat (vertical plane) and the protruding face 45b is also made flat. However, the surface 45c of the stack link 45 configuring the drive portion of the bill processing apparatus of the present invention does not have to be made flat, and may be made curved. Naturally, the protruding face 45b does not have to be made flat, and may be made curved.

Explanation of the bill processing apparatus of the following embodiments (embodiments 2 through 4) is provided by omitting the description of the parts that are same as in the bill processing apparatus 1 of the first embodiment (for example, stack motor 42 and the like), as well as the reference numerals described in the figures.

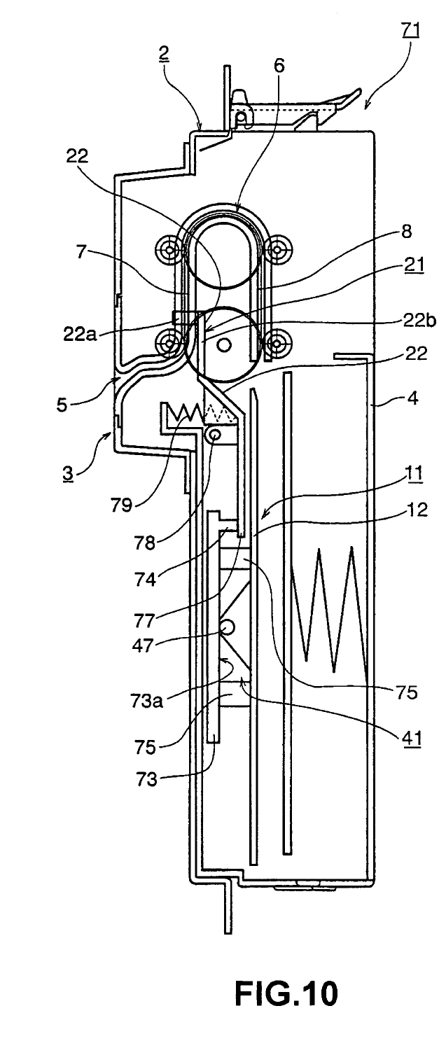

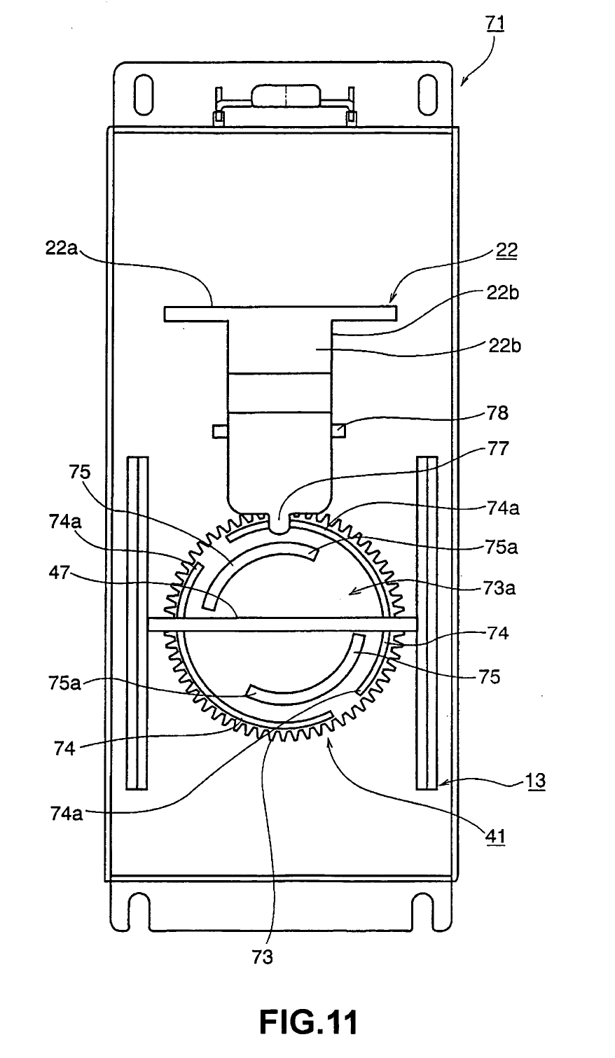

FIG. 10 is a schematic cross sectional view of a substantial part of the bill processing apparatus of a second embodiment of the present invention, and shows particularly a condition in which the bill storage operation is not performed by the stack portion, and a first passage is closed by the shutter portion. FIG. 11 is a schematic cross sectional view of a substantial part of the bill processing apparatus of FIG. 10. It should be noted in FIG. 10 and FIG. 11 that the parts same as those in FIG. 1 through FIG. 9 are indicated with the same reference numerals.

In a bill processing apparatus 71 of the second embodiment, the shutter portion 21 is configured by the shutter lever 22 disposed in the first passage 7, as shown in FIG. 10.

It should be noted that a reference numeral 79 in FIG. 10 is a shutter spring which is engaged with the front end 22a side of the shutter lever 22 and the apparatus main body 2 and constantly biases the front end 22a side of the shutter lever 22 toward the bill storage portion 4.

As shown in FIG. 11, in the bill processing apparatus 71 of the second embodiment, the shutter lever 22 is engaged directly to a gear for bill storage operation 73, without using the link structure configured by the stack cam 44, stack link 45, and stack roller 46 as in the bill processing apparatus 1 of the first embodiment.

Specifically, the drive portion 41 comprises, instead of the stack cam 44, stack link 45, and stack roller 46 of the bill processing apparatus 1 of the first embodiment, the gear 73 coupled to the gear of the stack motor 42, a pair of protrusions for stack operation 75, which are formed on a surface of rotation of the gear 73, and a pair of protrusions for shutter operation 74, which are formed on the surface of rotation of the gear 73.

It should be noted that the surface of rotation of the gear 73 is formed so as be a flat surface 73a.

Moreover, the protrusions for shutter operation 74 are in the form of a circular protrusion. Each of the upper surfaces of the protrusions for shutter operation 74 (referred to as “inclined surface” hereinafter) is inclined toward the bill storage portion 4 such that the height from the flat surface 73a of the gear 73 to the ends 74a is higher than that from the flat surface to the other ends.

Furthermore, between one of the end 74a of the protrusions for shutter operation 74 and the other end of the other protrusion for shutter operation 74, there is formed a space which allows a protrusion 77 of the shutter lever 22 to be welded with pressure to the flat surface 73a of the gear 73.

Moreover, the protrusions for stack operation 75 are in the form of a circular protrusion so as to be formed on a periphery that is inner than the protrusions for shutter operation 74. Furthermore, each of the upper surfaces of the protrusions for stack operation 75 (referred to as “inclined surface” hereinafter) is inclined toward the bill storage portion 4 such that the height from the flat surface 73a of the gear 73 to the ends 75a is higher than that from the flat surface to the other ends. Furthermore, between one of the end 75a of the protrusions for stack operation 75 and the other end of the other protrusion for stack operation 75, there is formed a space which allows the stack shaft 47 to be welded with pressure to the flat surface 73a of the gear 73.

In the bill processing apparatus 71 of the second embodiment in such configuration, as shown in FIG. 10 and FIG. 11, in the standby state the protrusion 77 of the shutter lever 22 is welded with pressure to the inclined surface on the other end side of one of the protrusions for shutter operation 74, whereby the shutter lever 22 rotates around an axis 78 while resisting the biasing force of the shutter spring 79, and causes the front end 22a to protrude to the first passage 7. Accordingly the first passage 7 is closed.

The stack shaft 47 is disposed on the flat surface 73a of the gear 73 between the pair of protrusions for stack operation 75, thus the lift table 12 which is coupled to the stack shaft 47 via the link arm 13 is disposed in a position farthest from the bill storage portion 4. Therefore, the back end of the second passage 8 is opened. It should be noted that the bill storage passage area 10 is also opened.

In this standby state, the stack motor 42 is driven, and the gear 73 is caused to rotate until the rotation angle of the gear 73 reaches the first predetermined angle. Then, the protrusion 77 of the shutter lever 22 is caused to descend from the inclined surface at the other end of one of the protrusions for shutter operation 75 by the biasing force of the shutter spring 79, and welded with pressure to the gear flat surface 73a between the pair of protrusions for shutter operation 75. Thus, the shutter lever 22 rotates around the axis 78 to cause the front end 22a to be ejected from the first passage 7, whereby the first passage 7 is opened.

At this time, the stack shaft 47 still remains in the state of being welded with pressure to the gear flat surface 73a between the pair of protrusions for stack operation 75, thus the lift table 12 remains in the state of being disposed in the position farthest from the bill storage portion 4. Therefore, the back end of the second passage 8 remains opened.

Next, the stack motor 42 is driven and the gear 73 is caused to rotate until the rotation angle thereof reaches the second predetermined angle. Consequently, the protrusion 77 of the shutter lever 22 reaches the end 74a side of the protrusion for shutter operation 74, and moves up on the inclined surface of the protrusion for shutter operation 74. Therefore, the shutter lever 22 rotates around the axis 78 while resisting the biasing force of the shutter spring 79. Then, when the rotation angle of the gear 73 reaches the second predetermined angle, the front end 22a of the shutter lever 22 finally protrudes to the first passage 7, whereby the first passage 7 is closed.

Moreover, the stack shaft 47 at this time still remains in the state of being welded with pressure to the gear flat surface 73 between the pair of protrusions for stack operation 75, thus the lift table 12 remains in the state of being disposed in the position farthest from the bill storage portion 4. Therefore, the back end of the second passage 8 remains opened.

Next, the stack motor 42 is driven and the gear 73 rotates until the rotation angle thereof reaches the third predetermined angle. Consequently, the stack shaft 47 reaches the end 75a side of the protrusion for stack operation 75 and moves up on the inclined surface thereof. Then, when the gear 73 rotates until the third predetermined angle is reached, the stack shaft 47 that moves up resists the biasing force of the lift spring 19 (see FIG. 1), and the lift table 12 is caused to pass transversely across the back end of the second passage 8 and the bill storage passage area 10 and to move to a position which is the most proximate to the bill storage portion 4, whereby the bill can be stored in the bill storage portion 4.

The protrusion 77 at this time moves up on the inclined surface of the protrusions for shutter operation 74, thus the shutter lever 22 still remains in the sate where it causes the front end 22a to protrude to the first passage 7, whereby the first passage 7 remains in the closed state.

Next, as shown in FIG. 10 and FIG. 11, the gear 73 is further rotated in one direction by the drive of the stack motor 42 until the gear comes to a position where the rotation angle becomes the fourth predetermined angle (for example, 360 degrees), that is, a position of rotation in the standby state.

Consequently, the biasing force of the lift spring 19 causes the stack shaft 47 to descend from the inclined surface at the other end of the protrusion for stack operation 75, and to be welded with pressure to the gear flat surface 73a between the pair of protrusions for stack operation 75. Therefore, the lift table 12 passes transversely across the back end of the second passage 8 and the bill storage passage area 10 to return to the standby position which is farthest from the bill storage portion 4, whereby the back end of the second passage 8 is opened.

Moreover, the protrusion 77 of the shutter lever 22 remains in the state of being welded with pressure to the inclined surface at the other end of the protrusions for shutter operation 74. Therefore, the front end 22a of the shutter lever 22 is caused to protrude to the first passage 7, whereby the first passage 7 is kept in the standby position where it is closed, and then the standby state is returned.

As described above, the bill processing apparatus 71 of the second embodiment comprises the shutter portion 21 for opening and closing the bill conveyance path 6, the stack portion 11 for storing a bill guided along the bill conveyance path 6 into the bill storage portion 4, and the drive portion 41 for driving the shutter portion 21 and the stack portion 11 by means of the stack motor 42. Further, the drive portion 41 comprises the first driving member for driving the shutter portion 21, that is, for example, the protrusions for shutter operation 74, and the second driving member for driving the stack portion 11, that is, for example, the protrusions for stack operation 75.

The bill processing apparatus further has the unoperated region in which the stack portion 11 does not operate with respect to operation of the first driving member, of the first driving member and the second driving member, and has the unoperated region in which the shutter portion 21 does not operate with respect to operation of the second driving member.

For this reason, as in the bill processing apparatus 1 of the embodiment 1, the bill processing apparatus 71 can secure the state in which the first passage 7 is opened by the shutter portion 21 and the back end of the second passage 8, that is, the back end of the bill conveyance path 6, is not closed by one end of the lift table 12, whereby the bill storage passage area 10 communicated with the back end of the bill conveyance path 6 can be used as a part of the passage for temporarily holding the bill. Therefore, miniaturization of the bill processing apparatus can be achieved with this bill processing apparatus 71.

It should be noted in the bill processing apparatus 71 that an angle for disposing the protrusions for shutter operation 74 on the gear 73, an angle for disposing the protrusions for stack operation 75 on the gear 73, and the dispositional relationship between them are adjusted in order to obtain the unoperated region, as shown in FIG. 11.

Further, in the bill processing apparatus 71 of the second embodiment, the shutter lever 22 of the shutter portion 21 is directly engaged with the gear for bill storage operation 73 to operate the shutter portion 21, thus space in the apparatus main body 2 can be saved more in comparison with the bill processing apparatus 1 of the first embodiment, because the link structure configured by the stack cam 44, stack link 45, and stack roller 46 as in the bill processing apparatus 1 of the first embodiment is not used.

It should be noted in the bill processing apparatus 71 of the second embodiment that the first passage 7 is opened and closed by the shutter portion 21. However, in this case, it goes without saying that the first passage 7 which is opened and closed by the shutter portion 21 may be disposed inside the apparatus main body 2, or may be formed between the apparatus main body 2 and the front mask 3.

Also in the bill processing apparatus 71 of the second embodiment, the shutter portion 21 is engaged directly with the gear for bill storage operation 73 to operate the shutter portion 21; however, in the bill processing apparatus of the present invention, the structure is not limited to this configuration where the gear 73 is used, thus, for example, a another gear for shutter operation may be engaged to the gear for bill storage operation 73 to engage the shutter portion to the abovementioned gear.

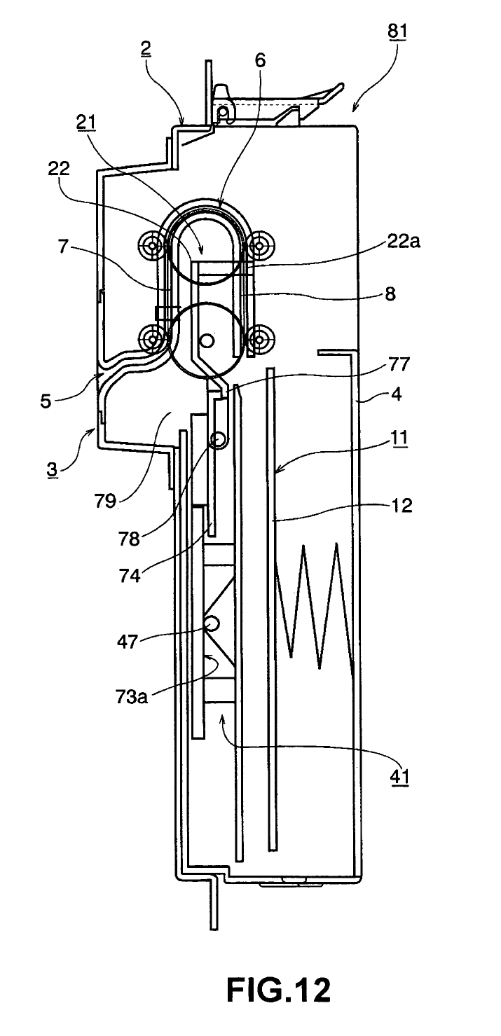

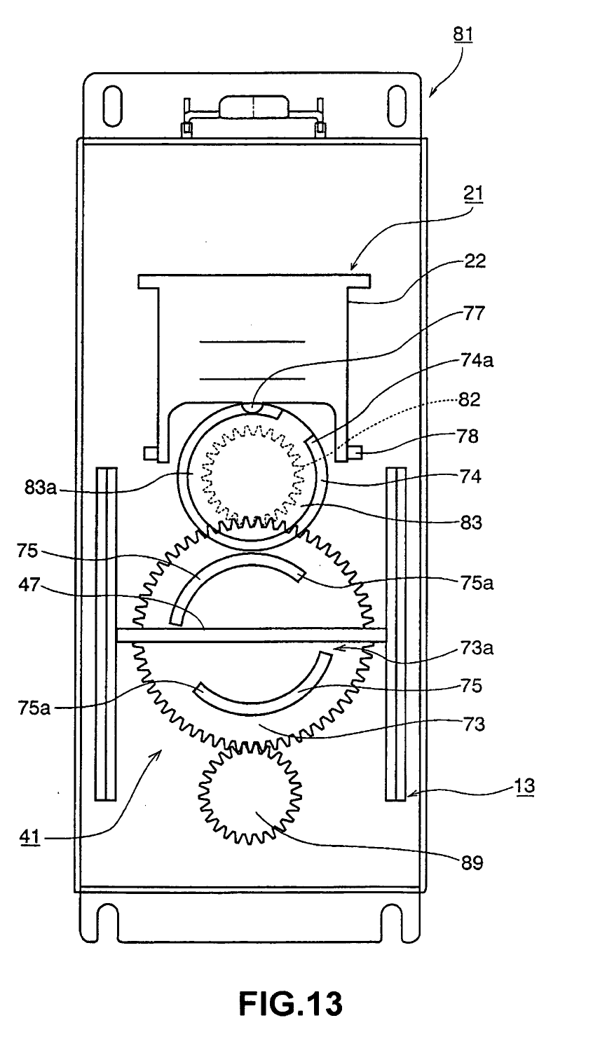

FIG. 12 is a schematic cross sectional view of a substantial part of the bill processing apparatus of a third embodiment of the present invention, and shows particularly a condition in which the bill storage operation is not performed by the stack portion, and a second passage is closed by the shutter portion, and FIG. 13 is a schematic cross sectional view of a substantial part of the bill processing apparatus of FIG. 12. It should be noted in FIG. 12 and FIG. 13 that the parts used in FIG. 1 through FIG. 11 are indicated with the same reference numerals.

As shown in FIG. 13, in a bill processing apparatus 81 of the third embodiment, another gear 82 for shutter operation is engaged to the gear for bill storage operation 73 of the bill processing apparatus 71 of the second embodiment. Moreover, a cam 83 is fixed to the gear 82, and the protrusion 77 of the shutter portion 21 is engaged to the protrusion for shutter operation 74 of the cam 83. It should be noted that a reference numeral 89 is a gear of the stack motor 42 (FIG. 1).

The protrusions for shutter operation 74 are circular protrusions.

Each of the upper surfaces of the protrusions for shutter operation 74 (referred to as “inclined surface” hereinafter) is inclined toward the bill storage portion 4 such that the height from the surface of rotation of the cam 83 to the ends 74a is higher than that from the surface of rotation of the cam to the other ends. Furthermore, between one end and the other end of one of the protrusion for shutter operation for shutter operation 74, there is formed a space which allows the protrusion 77 of the shutter portion 21 to be welded with pressure to a flat surface 83a of the cam 83. It should be noted that the surface of rotation of the cam 83 is formed so as to be the flat surface 83a.

In the bill processing apparatus 81, there is disposed an unshown shutter spring for constantly biasing the front end 22a of the shutter portion 21 toward the first passage 7.

In the bill processing apparatus 81 of the third embodiment in such configuration, as shown in FIG. 12 and FIG. 13, in the standby state the protrusion 77 of the shutter lever 22 is welded with pressure to the inclined surface on the other end side of one of the protrusions for shutter operation 74, whereby the shutter lever 22 rotates around the axis 78 while resisting the biasing force of the above-described shutter spring, and causes the front end 22a to protrude to the second passage 8. Accordingly the second passage 8 is closed.

The stack shaft 47 is disposed on the flat surface 73a of the gear 73 between the pair of protrusions for stack operation 75, thus the lift table 12 which is coupled to the stack shaft 47 via the link arm 13 is disposed in the position farthest from the bill storage portion 4. Therefore, the back end of the second passage 8 is opened. It should be noted that the bill storage passage area 10 is also opened.

In this standby state, the stack motor 42 is driven, and the gear 73 is caused to rotate in a predetermined direction until the rotation angle of the gear 73 reaches the first predetermined angle. Then, the cam 83 is caused to rotate in a predetermined direction via the gear 82 by the rotation of the 73. Accordingly, the protrusion 77 of the shutter lever 22 is caused to descend from the inclined surface at the other end of the protrusion for shutter operation 75 by the biasing force of the above-described shutter spring, and welded with pressure to the flat surface 83a of the cam 83 between the pair of protrusions for shutter operation 75. Thus, the shutter lever 22 rotates around the axis 78 to cause the front end 22a to be ejected from the second passage 8, whereby the second passage 8 is opened.

At this time, the stack shaft 47 still remains in the state of being welded with pressure to the flat surface 73a of the gear 73 between the pair of protrusions for stack operation 75, thus the lift table 12 remains in the state of being disposed in the position farthest from the bill storage portion 4. Therefore, the back end of the second passage 8 remains opened.

Next, the stack motor 42 is driven and the gear 73 is caused to rotate in a predetermined direction until the rotation angle thereof reaches the second predetermined angle. Consequently, the cam 83 rotates in a predetermined direction via the gear 82, thus the protrusion 77 of the shutter lever 22 reaches the end 74a side of the protrusion for shutter operation 74, and moves up on the inclined surface of the protrusion for shutter operation 74. Therefore, the shutter lever 22 rotates around the axis 78 while resisting the biasing force of the above-described unshown shutter spring. Then, when the rotation angle reaches the second predetermined angle, the front end 22a of the shutter lever 22 finally protrudes to the second passage 8, whereby the second passage 8 is closed.

Moreover, the stack shaft 47 still remains in the state of being welded with pressure to the flat surface 73a of the gear 73 between the pair of protrusions for stack operation 75, thus the lift table 12 which is coupled to the stack shaft 47 via the stack arm (lift arm) 13 remains in the state of being disposed in the position farthest from the bill storage portion 4. Therefore, the back end of the second passage 8 remains opened.

Next, the stack motor 42 is driven and the gear 73 rotates in a predetermined direction until the rotation angle thereof reaches the third predetermined angle. Consequently, the stack shaft 47 reaches the end 75a side of the protrusion for stack operation 75 and moves up on the inclined surface thereof. Then, when the gear 73 rotates until the third predetermined angle is reached, the stack shaft 47 that moves up resists the biasing force of the lift spring 19 (see FIG. 1), and the lift table 12 is caused to pass transversely across the back end of the second passage 8 and the bill storage passage area 10 and to move to a position which is the most proximate to the bill storage portion 4, whereby the bill can be stored in the bill storage portion 4.

It should be noted that the protrusion 77 at this time moves up on the inclined surface of the protrusion for shutter operation 74, thus the shutter lever 22 still remains in the sate where it causes the front end 22a to protrude to the second passage 8, whereby the second passage 8 remains in the closed state.

Next, as shown in FIG. 12 and FIG. 13, the gear 73 is further rotated in a predetermined direction by the drive of the stack motor 42 until the gear comes to a position where the rotation angle becomes the fourth predetermined angle (for example, 180 degrees), that is, a position of rotation in the standby state.

Consequently, the biasing force of the lift spring 19 causes the stack shaft 47 to descend from the inclined surface at the other end of the protrusion for stack operation 75, and to be welded with pressure to the flat surface 73a of the gear 73 between the pair of protrusions for stack operation 75. Therefore, the lift table 12 passes transversely across the back end of the second passage 8 and the bill storage passage area 10 to return to the standby position which is farthest from the bill storage portion 4, whereby the back end of the second passage 8 is opened.

Although the cam 83 rotates in the predetermined direction via the gear 82, the protrusion 77 of the shutter lever 22 remains in the state of being welded with pressure to the abovementioned upper surface at the other end of the protrusion for shutter operation 74 by the biasing force of the shutter spring 79. Therefore, the front end 22a of the shutter lever 22 is caused to protrude from the second passage 8, whereby the standby position where the second passage 8 is closed is maintained, and then the standby state is returned.

As with the bill processing apparatus 71 of the second embodiment, the bill processing apparatus 81 of the third embodiment has the unoperated region in which the stack portion 11 does not operate with respect to operation of the first driving member (for example, the protrusions for shutter operation 74), of the first driving member and the second driving member, and has the unoperated region in which the shutter portion 21 does not operate with respect to operation of the second driving member (for example, the protrusions for stack operation 75).

For this reason, the bill processing apparatus 81 can secure a state in which the second passage 8 is opened by the shutter portion 21 and the back end of the second passage 8, that is, the back end of the bill conveyance path 6, is not closed by the lift table 12.

Therefore, the bill storage passage area 10 communicated with the back end of the bill conveyance path 6 can be used as a part of the passage for temporarily holding the bill, whereby miniaturization of the bill processing apparatus can be achieved with this bill processing apparatus 81.

It should be noted in the bill processing apparatus 81 that an angle for disposing the protrusions for shutter operation 74 on the cam 83, an angle for disposing the protrusions for stack operation 75 on the gear 73, and the dispositional relationship between them are adjusted in order to obtain the unoperated region, as shown in FIG. 13.

Further, in the bill processing apparatus 81 of the third embodiment, the shutter portion 21 is welded with pressure to the protrusion for shutter operation 74 of the cam 83 of the gear 82 which is engaged with the gear for bill storage operation 73 to operate the shutter portion 21. Therefore, space in the apparatus main body 2 can be saved more in comparison with the bill processing apparatus 1 of the first embodiment, because the link structure configured by the stack cam 44, stack link 45, and stack roller 46 as in the bill processing apparatus 1 of the first embodiment as well as in the bill processing apparatus 71 of the second embodiment is not used.

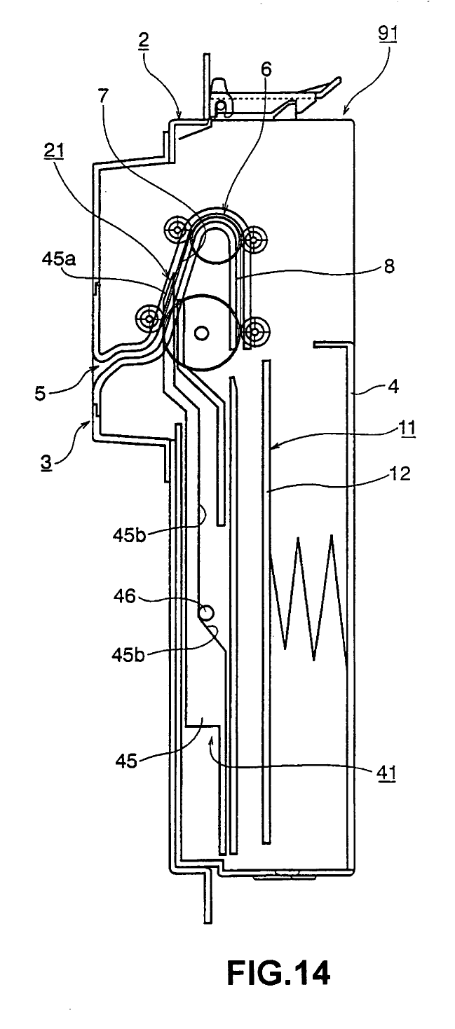

FIG. 14 is a schematic cross sectional view of a substantial part of the bill processing apparatus of a fourth embodiment of the present invention, and shows particularly a condition in which the bill storage operation is not performed by the stack portion, and the first passage 7 is closed by the shutter portion. It should be noted in FIG. 14 that the parts used in FIG. 1 through FIG. 13 are indicated with the same reference numerals.

The bill processing apparatus 1 of the first embodiment is provided with the shutter lever 22 and the stack link 45 independently. In a bill processing apparatus 91 of the fourth embodiment, however, the shutter lever 22 that appears in the first passage 7 to open and close the first passage 7, and the stack link 45 are configured integrally.

The bill processing apparatus 91 of the fourth embodiment comprises the shutter portion 21 for opening and closing the bill conveyance path 6, the stack portion 11 for storing a bill guided along the bill conveyance path 6 into the bill storage portion 4 (see FIG. 1), and the drive portion 41 for driving the shutter portion 21 and the stack portion 11 by means of the stack motor 42. Further, the drive portion 41 comprises the first driving member for driving the shutter portion 21, that is, for example, the front end 45a of the stack link 45 (note that the front end 45a by itself functions as a shutter for opening and closing the bill conveyance path 6), and the second driving member for driving the stack portion 11, that is, for example, the protruding face 45b of the stack link. The bill processing apparatus further has the unoperated region in which the stack portion 11 does not operate with respect to operation of the first driving member, of the first driving member and the second driving member, and has the unoperated region in which the shutter portion 21 does not operate with respect to operation of the second driving member.

For this reason, the bill processing apparatus 91 can secure the state in which the second passage 8 is opened by the shutter portion 21 and the back end of the second passage 8, that is, the back end of the bill conveyance path 6, is not closed by one end of the lift table 12, whereby the bill storage passage area 10 communicated with the back end of the bill conveyance path 6 can be used as a part of the passage for temporarily holding the bill. Therefore, miniaturization of the bill processing apparatus can be achieved with this bill processing apparatus 91.

Further, the shutter lever 22 and the stack link 45 are not disposed independently in the bill processing apparatus 91 of the fourth embodiment as in the bill processing apparatus 1 of the first embodiment, thus the number of parts can be reduced and the production cost for the bill processing apparatus can be reduced.

Furthermore, in the bill processing apparatus 91 of the fourth embodiment, the first passage 7 is disposed so as to be inclined with respect to the vertical direction so that the front end 22a of the stack link 45 which moves in a straight line can easily protrude to the first passage 7.

Moreover, in the bill processing apparatus 91 of the fourth embodiment, the stack link 45 itself is disposed in the first passage 7, thereby opening and closing the first passage 7. However, the stack link 45, which is also a shutter lever, may be disposed in the second passage 8 to open and close the second passage 8.

The above-described bill processing apparatus of the present invention can be utilized as a small bill processing apparatus disposed inside a machine main body such as an automatic vending machine, and is suitable for use in preventing mischief performed by a user of an automatic vending machine or the like, as much as possible.

The present invention can be executed in various other forms without departing from its spirit or main characteristics. Therefore, the present invention should not be understood as limited to the above-described embodiments, as they are merely examples in all respects. The scope of the present invention is indicated by the Claims but not limited to the text of the specification. Furthermore, deformations and changes belonging to the average scope are all within the scope of the invention.

What is claimed is:

1. A bill processing apparatus having shutter means for opening and closing a bill conveyance path and stack means for storing a bill which is guided along the bill conveyance path into a bill storage portion, the apparatus including drive means for causing a single drive portion to drive the shutter means and the stack means,
wherein the drive means comprises:
a first driving member that drives the shutter means;
a second driving member that drives the stack means; and
an unoperated region in which the shutter means or the stack means does not operate with respect to the operation of at least one of the first driving member and the second driving member.

2. The bill processing apparatus according to claim 1, further comprising an apparatus main body that supports the bill storage portion, and a bill-discriminating portion that is detachably supported by the apparatus main body,
wherein the shutter means is disposed in the bill-discriminating portion.

3. The bill processing apparatus according to claim 1, wherein the bill conveyance path comprises a first passage communicated with a bill slot and a second passage communicated with the first passage and forming a back end of the bill conveyance path; and
the shutter means is formed in the second passage.

4. The bill processing apparatus according to claim 1, wherein
the drive means comprises:
a stack motor;
a stack cam engaged with the stack motor to rotate;
a stack link that has a front end disposed facing the shutter means, a surface formed along a direction perpendicular to a direction toward the bill storage portion, and a protruding face connected to the surface and protruding toward the bill storage portion, the stack link being engaged with the stack cam, moved in a direction toward the shutter means or in a direction opposite therefrom, and causing the shutter means to operate by the front end;
a stack roller that moves up and down on the protruding face from a position abutting on (or slightly distant from) the surface by the movement of the stack link;
a stack shaft that supports the stack roller and moves in a direction toward the bill storage portion or in a direction opposite therefrom by the stack roller moving up and down; and
a stack arm with a pantograph structure, that fittingly inserts the stack shaft, is engaged with the stack means, and causes the stack means to move toward the bill storage portion or in the direction opposite therefrom.

5. The bill processing apparatus according to claim 4, wherein
the first driving member comprises the front end of the stack link that is engaged with the shutter means; and
the second driving member comprises the protruding face of the stack link abutting on the stack roller.
